(19) United States
(12) Patent Application Publication
(10) Pub. No.: US 2014/0256307 A1
(43) Pub. Date: Sep. 11, 2014

(54) Combination Device with a Long Distance Remote Cell Phone, Having Functional Control Items and Being Mix-operated by Voice and Touch, and a Receiving Switching Controller

(71) Applicant: WAVESHIELDING TECHNOLOGY CO., LTD., Taoyuan County (TW)

(72) Inventor: Liann-Be Chang, Taoyuan County (TW)

(73) Assignee: Waveshielding Technology Co., Ltd., Taoyuan County (TW)

(21) Appl. No.: 13/792,311

(22) Filed: Mar. 11, 2013

(51) Int. Cl. H04W 4/00

(52) U.S. Cl. CPC H04W 4/001
USPC 455/420

(57) ABSTRACT

A combination device with a long distance remote cell phone, having functional control items and being mix-operated by voice and touch, and a receiving switching controller, comprising a parental control cell phone, having functional control items and being mix-operated by voice and touch and a receiving switching controller, is provided. The receiving switching controller receives messages and compares phone numbers or web addresses of a white list to allow follow-up tasks or communications, which comprise corresponding decoding, activating video communication, multi-functional code storage, and corresponding output by driving circuit and relay.

### BACKGROUND OF THE INVENTION

1. Field of the Invention

The present invention relates to a combination device with high safety and with a long distance remote cell phone, which is operated by touch or voice, and a receiver to take care of disabled people, pregnant women, children, or elders.

2. Descriptions of the Related Art

The present remote control systems are:
1. known cell phone remote device, which uses an incoming number as a password and activates the electrical device needed to be remote-controlled after the comparison leads to a right result. However, it takes much time and expensive call charges during confirmation when plenty of options are operated through the cell phone. Moreover, voice and touch mix-operation is neither provided. All above means such device is inconvenient for nowadays smart phones when the user is moving.
2. known remote control device with phone. Voice control system and driving circuits are configured at the rear area of a receiving device of a public system for users to dial to the receiving device by cell phone. After the incoming call is answered, the voice control system inquires the passwords of the user and provides functional options after the recognition is confirmed. The voice control system guides the user to complete the operations which is needed to be controlled, and the driving circuits finish the remote control operations. However, the incoming call is needed to be answered first for the following remote control operations in such remote control device. For voice clarity and lessening errors, the voice control system guides with a slow speed, which leads to high costs of call charges, occupation of common channels and wastes of public goods. Furthermore, the safety is controlled by only once password input, which is easily cracked and endangers the safety of the users and residents.
3. another known cell phone with IR remote control device. The IR technology is well developed in near end control, but it's not applicable for long distance remote control. Therefore, IR technology is hard to be put in use for cell phone remote control technology field.

The development of technology enables people to operate devices with remote controller in their daily life. Thereby, operations of all kinds of appliances are more convenient and the space for appliances is more flexible for use. Users don't have any problem about manual controls. For avoiding interference between remote controllers, each appliance corresponds to an independent remote controller, which results in carrying and memorizing the functional operations between remote controllers and corresponding appliances and persecutes users. Besides, it's society's obsession when disabled people, pregnant women, children, or elders are alone and forget to bring keys with them or special situation happened to them and they can't solve the problem by themselves or assist people get inside the house to help them. The applicant focused on development of roll-up door remote control for over ten years. As the development and improvement of cell phones, the combination of cell phones and roll-up door remote controllers can be further improved for the needs of children and elders. Therefore, how to provide a combination device with high safety and with a long distance remote cell phone, being operated by voice and touch, and a receiver, is a continuing goal of the related industry and researchers.

### SUMMARY OF THE INVENTION

To solve the above mentioned problems, the present invention provides a combination device (FIG. 1) with high safety and with a long distance remote cell phone, operated by voice and touch, and a receiver. The device comprises a parental control cell phone (11) with such functional control items and a receiving switching controller (12) at the receiving end. The receiving switching controller (12) is automatically activated to transmit audio/video, pictures, the states or management operations of each control ends to the parental control cell phone (11) after the certification.

The parental control cell phone (11) has at least one control functional option (111), which has the content at least comprising the names, numbers or web addresses of the controlled objects. When the controlled object is a multi-end output control unit, the content further comprises a second part, such as a subname or a corresponding code. The content of the option at least comprises transmitting the host number, transmitting the host web address, sharing numbers or sharing web addresses.

When setting the parental control cell phone, the parental control cell phone is activated first. The parental control cell phone inquires the user about services items with voice or a frame, and the user answers or touches the control functional options. The parental control cell phone then inquires the user about safety certifications, which are set as numbers, voiceprints, fingerprints or face prints. When comparison and recognition are confirmed, the parental control cell phone inquires the user about control items with voice or a frame to make sure the operation option is a physical operation or a management operation. Then, the parental control cell phone inquires the name of the controlled object or the name of the controlled unit, and the user answers the name of the controlled object and the corresponding tasks. The parental control cell phone thus sends the operation codes through the cell phone or internet.

The receiving switching controller (12) receives messages through a cell phone receiving unit or an internet receiving unit. The received messages are checked if it belongs to the phone number or the web address of the white list, and the follow-up tasks or communications, which comprise video communication or related decoding. The receiving switching controller of the system has a receiving unit, which is a cell phone receiving unit or an internet receiving unit, a white list storing and a comparing unit. More preferably, the receiving switching controller further comprises a functional code storing and comparing unit and output ends of driving circuit and relay for corresponding outputs.

### BRIEF DESCRIPTION OF THE DRAWINGS

FIG. 1 is a schematic drawing of the present invention;

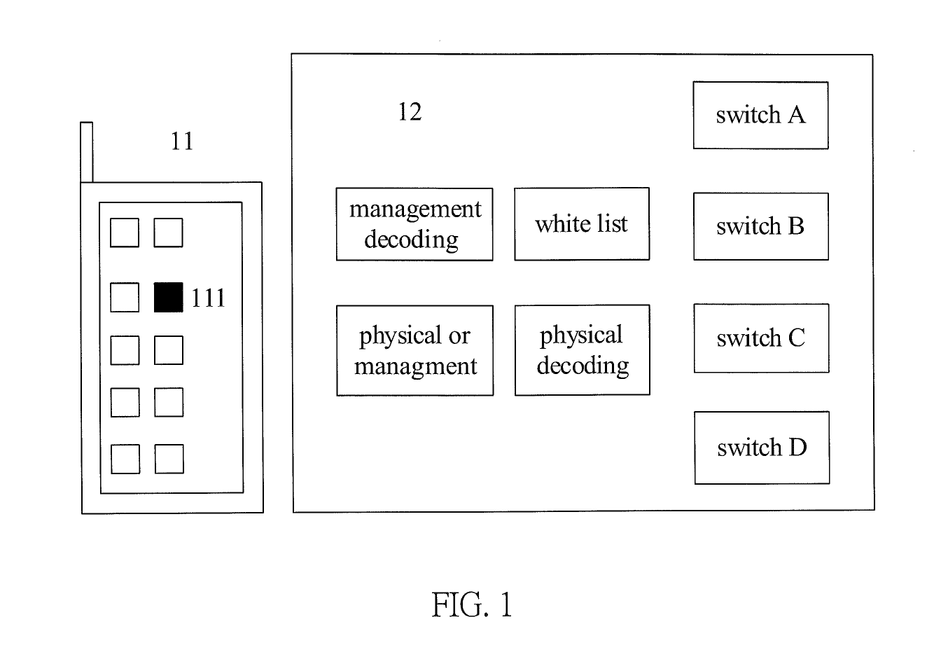

FIG. 2 is a flow diagram of setting management operations of the receiving end of the present invention;

FIG. 3A is a flow diagram of setting management operations of the parental control cell phone end of the present invention;

FIG. 3B is a flow diagram of setting physical operations of the parental control cell phone end of the present invention;

FIG. 4A is a flow diagram of receiving simple physical operation messages of the receiving end of the present invention;

FIG. 4B is a flow diagram of receiving multiple output physical operation messages of the receiving end of the present invention;

FIG. 5 is a code chart of multiple control under the physical operation items of the parental control cell phone of the present invention; and

FIG. 6 is a code chart of single control under the physical operation items of the parental control cell phone of the present invention.

### DESCRIPTION OF THE PREFERRED EMBODIMENT

The following will describe the detailed technology and preferred embodiments implemented for the subject invention with the aid of figures. However, the invention also may be embodied in other embodiments or other examples and should not limit to the embodiments described in the specification.

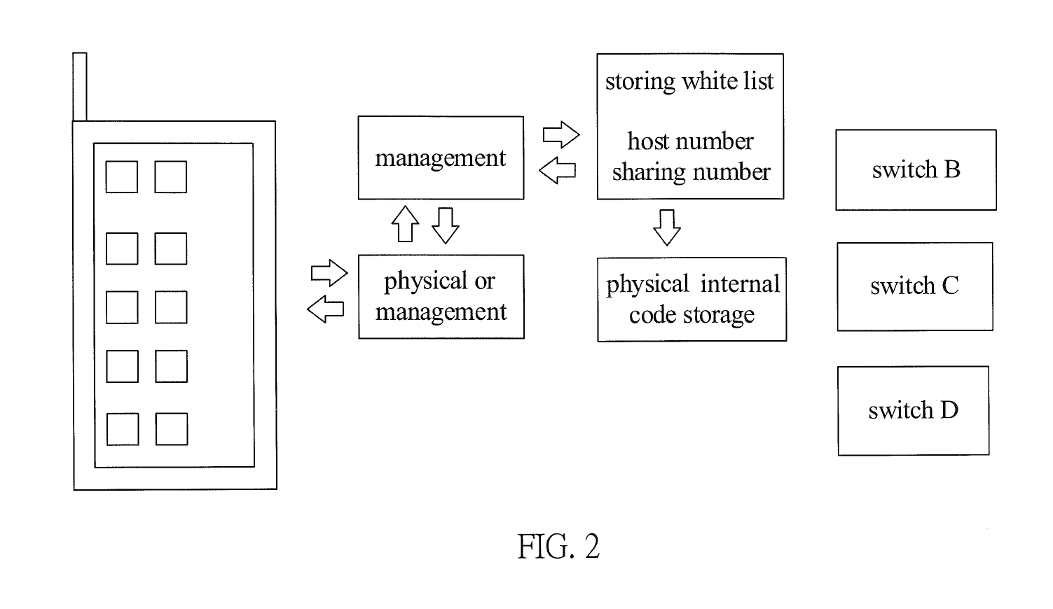

Referred to FIGS. 2 to 6, the present invention provides a long distance remote and receiving method with high safety and with a cell phone having functional control items and being operated by voice and touch and a device thereof. The method comprises executing control options with safety control functions, and a first layer safety control thereof is to compare voiceprints, fingerprints, face prints, or the combination thereof (FIG. 2). The operation setting and the operation input of the parental control cell phone are executed by voice or touch, and the operation input of the parental control cell is polled at least twice. The second layer safety control comprises manually inputting the content of operation options. The options of safety functional control items at least comprise a host name and a corresponding phone number or a web address. Each host name further comprises at least one operation subname and a corresponding operation code.

As shown in FIG. 2, the long distance remote control is operated by a parental control cell phone, a video phone, short message service or wireless internet. The receiving switching controller at least comprises a cell phone receiving unit or an internet receiving unit, a physical operation decoding unit, a management operation decoding unit, a white list storing and comparing unit, and a driving and output unit. The receiving switching controller receives internet messages, DTMF real time messages of telecommunication systems, such as GSM and CDMA, short text messages or number messages, and then it provides functions correspondingly. After the white list storing and comparing unit being operated, the physical and the management operation decoding unit is added with auto-activated bidirectional communication function to transmit audio/video messages back.

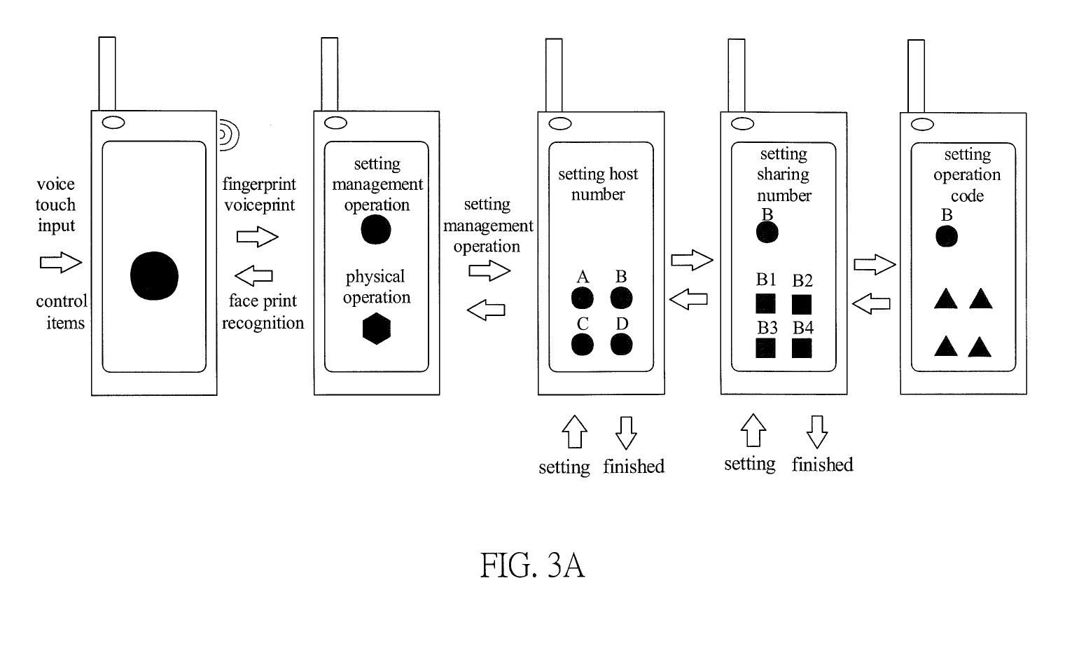

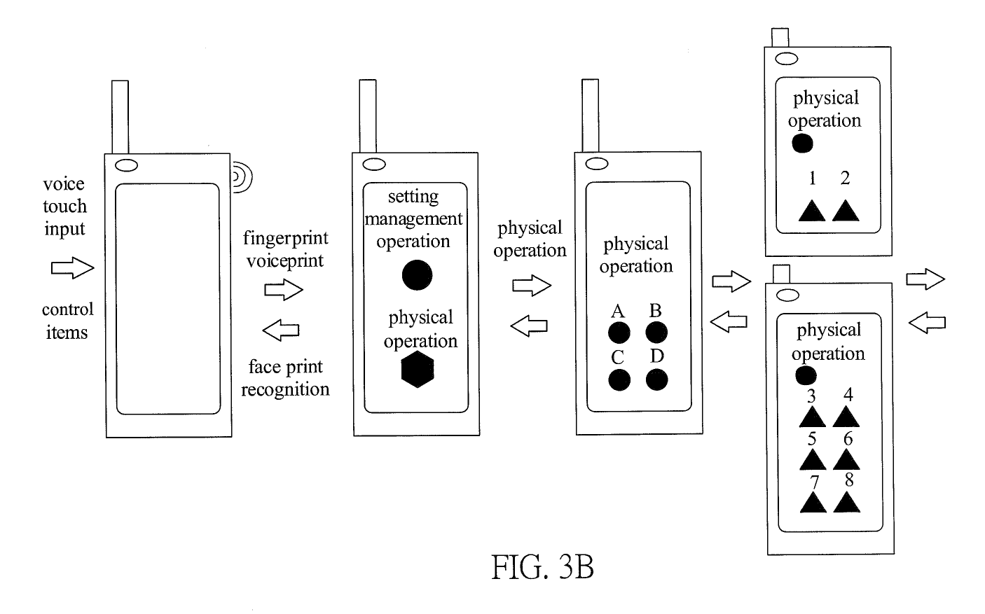

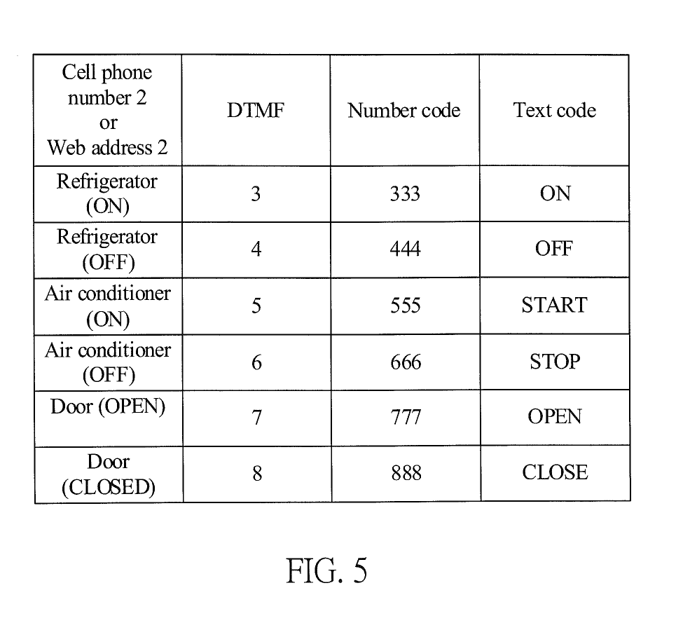

As shown in FIG. 3A, the parental control cell phone inquires the user about services items with voice or a frame and the user answers or touches the control functional options after the parental control cell phone is activated. The parental control cell phone then inquires the user about safety certifications, which are set as numbers, voiceprints, fingerprints or face prints, and such comparison is executed to ensure safety. The parental control cell phone inquires the user about control items with voice or a frame to make sure the operation option is a physical operation or a management operation. After the operation option is instructed, the host number or a sharing number, which can be set as the third layer password for safety, is input if the management operation is the single management operation. Then, the parental control cell phone inquires the name of the controlled object or the name of the controlled unit again, and the management operation code is sent through the cell phone or internet. The controlled object would response the corresponding result of setting the management tasks as shown in FIG. 5.

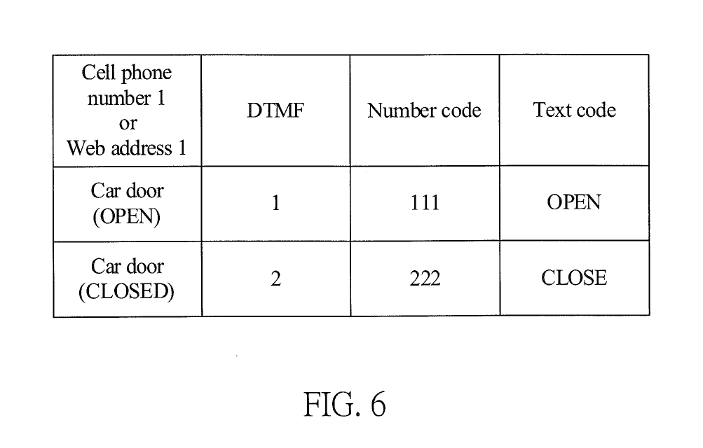

As shown in FIG. 3B, the parental control cell phone inquires the user about services items with voice or a frame and the user answers or touches the control functional options after the parental control cell phone is activated. The parental control cell phone then inquires the user about safety certifications, which are set as numbers, voiceprints, fingerprints or face prints, and such comparison is executed to ensure safety. The parental control cell phone inquires the user about control items with voice or a frame to make sure the operation option is a physical operation or a management operation after comparison and certification. After the operation option is instructed, the host number or a sharing number, which can be set as the third layer password for safety, is input if the management operation is the multiple management operation. Then, the parental control cell phone inquires the name of the controlled object or the name of the controlled unit again, and the management operation code is sent through the cell phone or internet. The controlled object would response the corresponding result of setting the management tasks. The parental control cell phone inquires the subname of the controlled object and the sub-operation code. The sub-operation code is stored in the receiving switching controller through the cell phone or internet. The controlled object would response the corresponding result of the setting tasks. The controlled object can be set and stored with the sub-operation code before it leave the factory as shown in FIG. 6.

As shown in FIG. 2, the parental control cell phone sent the operation code through the cell phone or internet. The receiving switching controller receives the messages from the parental control cell phone. The operation messages comprise physical operation and management operation. The management operation is operated by the second layer safety check. The management operation comprises setting the parental control cell phone, setting the sharing parental control cell phone, changing the parental control cell phone, changing the sharing cell phone and setting the sub-operation code. Then the controlled object would respond the corresponding result of setting the task.

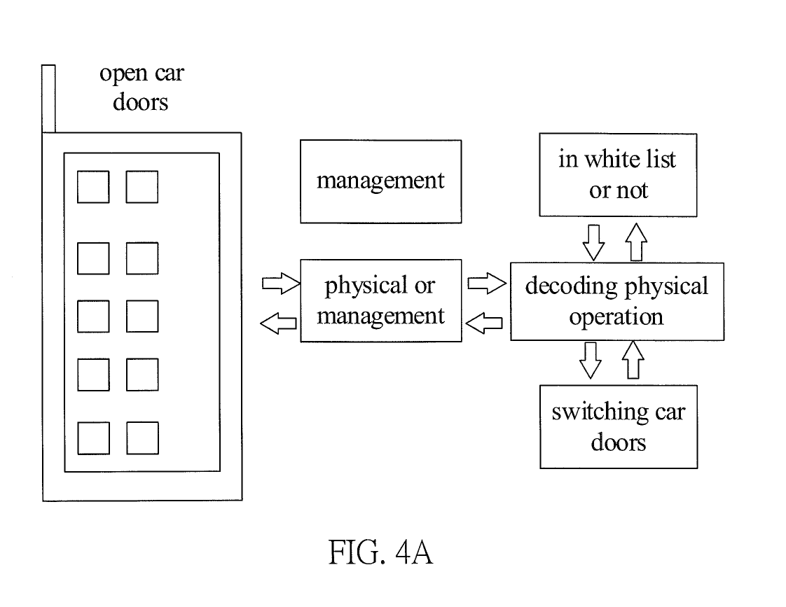

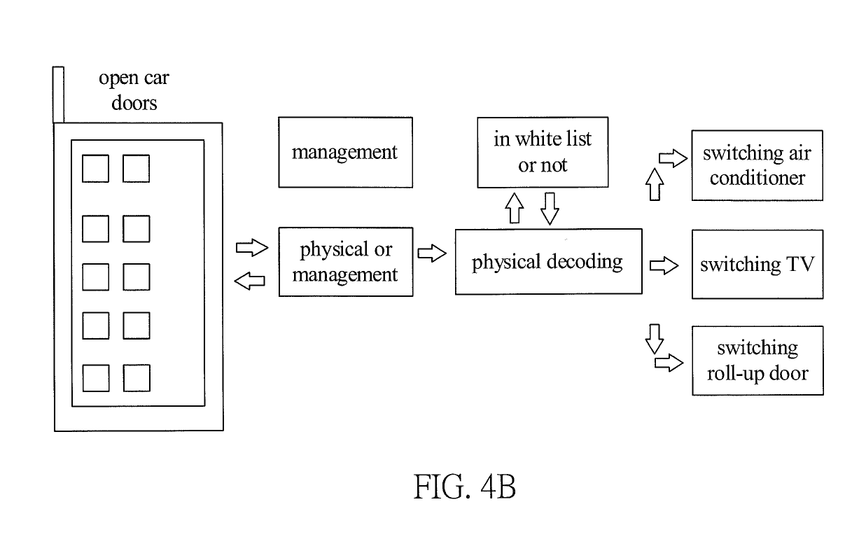

As shown in FIG. 4A, the parental control cell phone sends the physical operation code through the cell phone or internet. Take an automobile receiving switching controller for example, the physical operation is a single operation, which is operating for switching car doors, and the physical operation code is shown as FIG. 6. As shown in FIG. 4B, when taking a house receiving switching controller for example, the physical operation is multiple operation, which is operating for switching roll-up door, refrigerator and air conditioner, and the physical operation code is shown as FIG. 5. The operation code can be changed by remote controlling the parent control cell phone. When the operation of a parental control cell phone is a DTMF message, there's a DTMF decoding unit to process voice, numbers or text instructions. When the operation message is a DTMF message, it can be received from the audio message of the receiving controlling unit or the output end of the cell phone. The corresponding physical operation is output to the output relay at the rear end through the message decoding unit.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A combination device with a long distance remote cell phone, having functional control items and being mix-operated by voice and touch, and a receiving switching controller, comprising:
a parental control cell phone, having safety functional control items and being mix-operated by voice and touch; and
a receiving switching controller.

2. The combination device with a long distance remote cell phone, having functional control items and being mix-operated by voice and touch, and a receiving switching controller of claim 1, wherein the safety functional control items is controlled by comparing voiceprints, fingerprints, face prints, passwords and the combination thereof.

3. The combination device with a long distance remote cell phone, having functional control items and being mix-operated by voice and touch, and a receiving switching controller of claim 1, wherein a operation setting and a operation input of the parental control cell phone are executed by voice or touch, and a operation input of the parental control cell is polled at least twice.

4. The combination device with a long distance remote cell phone, having functional control items and being mix-operated by voice and touch, and a receiving switching controller of claim 1, wherein options of the safety functional control items at least comprises a host name, a corresponding phone number or a web address, and a corresponding operation code, and the operation of the parental control cell phone is long-distance remote controlled by a cell phone, a video phone, short message service, or wireless internet.

5. The combination device with a long distance remote cell phone, having functional control items and being mix-operated by voice and touch, and a receiving switching controller of claim 4, wherein each host name comprises a subname and a corresponding operation code.

6. The combination device with a long distance remote cell phone, having functional control items and being mix-operated by voice and touch, and a receiving switching controller of claim 1, wherein the receiving switching controller at least comprises a cell phone receiving unit, an internet receiving unit, a white list storing and comparing unit, a physical and a management operation decoding unit, and a driving and output unit.

7. The combination device with a long distance remote cell phone, having functional control items and being mix-operated by voice and touch, and a receiving switching controller of claim 6, wherein after the receiving switching controller receives a message from the parental control cell phone, an auto-activated bidirectional communication function is further executed for transmitting audio/video messages in addition to the white list storing and comparing unit and the physical and the management operation decoding unit.

8. The combination device with a long distance remote cell phone, having functional control items and being mix-operated by voice and touch, and a receiving switching controller of claim 1, wherein the receiving switching controller receives DTMF messages or short messages and correspondingly functions audio recording, video recording, camera rotation, or switching switches.

9. The combination device with a long distance remote cell phone, having functional control items and being mix-operated by voice and touch, and a receiving switching controller of claim 8, wherein the operation of a parental control cell phone is the DTMF messages, and a DTMF decoding unit output a corresponding operation.

10. The combination device with a long distance remote cell phone, having functional control items and being mix-operated by voice and touch, and a receiving switching controller of claim 8, wherein the DTMF messages is received by an audio message of the receiving switching controller or an output end of the cell phone.
